(19) United States
(12) Patent Application Publication
(10) Pub. No.: US 2021/0268945 A1
(43) Pub. Date: Sep. 2, 2021

(54) TEMPERATURE CONTROLLED CHILD SEAT

(71) Applicant: Gaylon Cook, Carrizo Springs, TX (US)

(72) Inventor: Gaylon Cook, Carrizo Springs, TX (US)

(21) Appl. No.: 16/805,878

(22) Filed: Mar. 2, 2020

(51) Int. Cl. B60N 2/56; B60N 2/26

(52) U.S. Cl. CPC B60N 2/5621; B60N 2/5685; B62B 9/00; B60N 2/5692; B60N 2/26

(57) ABSTRACT

A temperature controlled child seat device including a housing member, a coil assembly, a vent assembly, and a temperature control member. The housing member includes a seat cushion and a back rest. The coil assembly is embedded in the housing member and selectively produces heat and cooling in the seat cushion and back rest. The vent assembly is integrated in the housing member and includes a plurality of air openings and a vent line. The temperature control member initiates a two-stage heating or cooling operation in correspondence with a user selection of heating or cooling. The two-stage heating or cooling operation provides direct heating or cooling of the seat cushion and the back rest and provides heated or cooled air blown out of the vent assembly.

### FIELD OF THE INVENTION

Embodiments described herein generally relate to child seats, and more particularly to a temperature controlled child seat.

### BACKGROUND OF THE INVENTION

Ensuring that children are comfortable throughout various seasons is a major component of child care. However, during extreme temperatures this may be difficult, especially if the child is sedentary in a stroller or a car seat. The inability to manage temperature within these devices may cause discomfort for the child, and in extreme temperatures it may cause death. Hence, it is desirable to develop a means to manage the temperature of a child's stroller or a car seat.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary front view of a temperature controlled child seat according to an embodiment of the present disclosure.

### SUMMARY OF THE INVENTION

Exemplary embodiments disclosed herein describe a temperature controlled child seat device including a housing member, a coil assembly, a vent assembly, and a temperature control member. The housing member includes a seat cushion and a back rest. The coil assembly is embedded in the housing member and selectively produces heat and cooling in the seat cushion and back rest. The vent assembly is integrated in the housing member and includes a plurality of air openings and a vent line. The temperature control member initiates a two-stage heating or cooling operation in correspondence with a user selection of heating or cooling. The two-stage heating or cooling operation provides direct heating or cooling of the seat cushion and the back rest and provides heated or cooled air blown out of the vent assembly.

In some exemplary embodiments, the housing member is configured as a car seat.

In some exemplary embodiments, the housing member is configured as a stroller.

In some exemplary embodiments, the housing member includes a safety sensor for preventing the device from overheating.

In some exemplary embodiments, the coil assembly includes separate heating elements and cooling elements.

In some exemplary embodiments, the coil assembly includes a set of coils that may selectively operate as heating elements or cooling elements.

In some exemplary embodiments, the temperature control member includes control buttons for selecting a heating or cooling operation.

In some exemplary embodiments, a user can select a high or low setting for the heating or cooling operation.

In some exemplary embodiments, the temperature control member is a thermostat.

### DETAILED DESCRIPTION

The present disclosure relates to a temperature controlled child seat device (“the device”). The child seat may include a car seat or a stroller. The device ensures that the child is comfortable regardless of the weather by providing a temperature management system in the child seat. The device operates a two-stage temperature management system which provides temperature management by way of direct heating or cooling of a seat cushion and back rest, and by way of providing blown out heated or chilled air through a vent assembly integrated in the device. In effect, the device provides a two-stage heating or cooling operation.

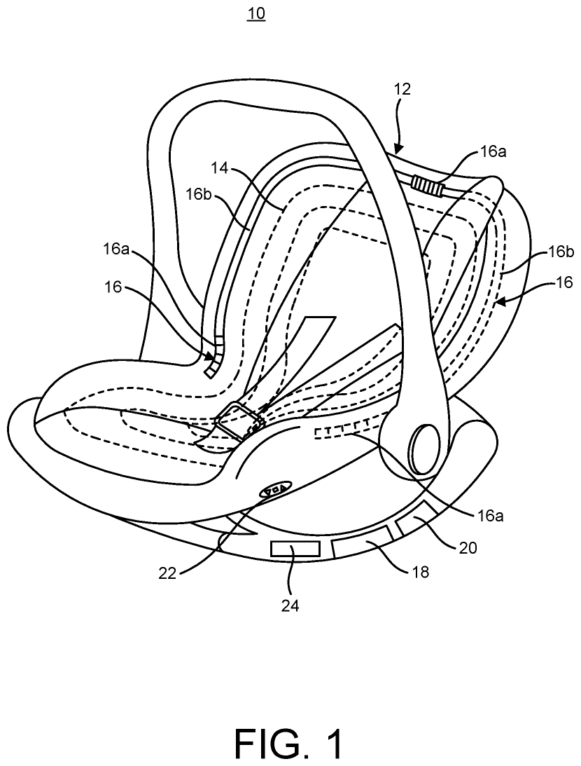

Turning to FIG. 1, the device 10 includes a housing member 12, a coil assembly 14, a vent assembly 16, a fan motor 18, a cooler/compressor 20, a temperature control member 22 and a battery compartment 24. The housing member 12 includes a seat cushion and back rest. The seat cushion receives a seat occupant. The back rest receives the occupant's back. The seat cushion and back rest include a padded layer of soft material (i.e., a cushion layer). The housing member 12 may be configured as a child car seat. Alternatively, the housing member may be configured as a child stroller.

The housing member includes a coil assembly 14 which is embedded beneath the seat cushion and the back rest. The coil assembly 14 may be placed beneath the cushion layer. The coil assembly selectively provides heat or cooling to the seat cushion and back rest. The coil assembly 14 may include separate heating and cooling elements. Alternatively, the coil assembly 14 may include coils that may operate as either a heating element or a cooling element. In the implementation of the coil assembly with separate heating elements and cooling elements, the heating elements may be implemented as resistive wires (i.e., metal coil) which produce heat when electricity flows through the coils, and the cooling elements may be implemented as liquid filled coils which produce direct cooling to the seat cushion when the liquid is chilled.

Where the heating elements are separate from the cooling elements, the heating operation (i.e., heating of the heating elements) may be controlled by a switch, such as, for example, a relay. When the switch is activated (e.g., by actuating a corresponding control button in the thermostat 22) to turn on the heating elements, a small current may flow through a coil in the relay. Near the coil is an open switch and when current flows through the coil, it creates a magnetic field, which pulls the switch closed. This completes a circuit, sending electricity from the battery to the heating elements in the seat cushion and back rest. As the electricity flows through the heating elements, it is resisted which causes friction that then produces heat throughout the heating elements. The heat produced throughout the heating elements produces direct heating of the seat cushion and the back rest and produces hot air when the fan motor 18 blows air over the heating elements, which is blown out of vent member 16.

Where the cooling elements are separate from the heating elements, the cooling operation (i.e., cooling of the cooling elements) may be controlled by a switch, which when activated (e.g., by actuating a corresponding control button in the thermostat 22) to turn on the cooling elements (i.e., to cool the device), causes the liquid to be cooled by the compressor 20 and sent by the fan motor 18 into the cooling elements which produces direct cooling of the seat cushion and back rest and produces chilled air that is blown out of the vent member 16.

In an alternative exemplary embodiment, the device 10 may include a heat exchanger, a pump, a fan motor assembly and a thermoelectric device (e.g., peltier device or heat pump) and the coil assembly may include heat exchanger coils. In this implementation, the coil assembly does not have separate heating and cooling elements. Instead, the coil assembly includes a set of coils (i.e., heat exchanger coils) that may selectively operate as heating elements or cooling elements. The thermoelectric device selectively heats and cools the heat exchanger filled with a liquid. The device may include a switch which determines the polarity of the voltage applied to the thermoelectric device, which in turn determines whether the liquid is heated or cooled. The switch may be operatively coupled to the thermostat control buttons for selecting a heating or cooling operation.

The liquid (heated or cooled) is forced through the coil assembly in the seat cushion and backrest by a pump and/or the fan motor 18. The heat produced throughout the heating elements when the heated liquid is forced therethrough produces direct heating of the seat cushion and the back rest and produces hot air when the fan motor 18 blows air over the heating elements, which is blown out of vent member 16. The cooling produced throughout the cooling elements when the cooled liquid is forced therethrough produces direct cooling of the seat cushion and the back rest and produces chilled air when the fan motor blows air over the cooling elements, which is blown out of vent member 16.

While exemplary embodiments of the present disclosure have described the coils as resistive wire, heat exchanger coils, etc., it should be noted that any suitable type of coil/coil assembly may be used in the system.

The housing member 12 has a vent assembly 16 integrated therein for blowing out temperature controlled air to the seat occupant. The vent assembly receives the air produced from the coil assembly and blown out by the fan motor 18. The vent assembly 16 includes a plurality of air openings 16a and a vent line 16b. The air openings 16a are positioned along the vent line 16b at different locations surrounding the seat occupant. The air openings may be individually opened or closed by means of a shutter-like structure enclosed therein which can be manually opened or closed. So, if the user only desires to provide direct heating/cooling of the seat cushion and the back rest and not provide temperature controlled air flow to the seat occupant, the user can close the air openings. The vent line 16b is positioned along the outer perimeter of the seat cushion and/or the back rest area thereby providing air flow around the seat occupant. The vent line acts as an air duct and provides a passageway for the air flow to travel to the plurality of air openings.

The housing member 12 has a temperature control member 22, (i.e., thermostat) integrated therein for regulating and monitoring the temperature of the seat cushion and the back rest and for regulating and monitoring the temperature of the air blown out of the plurality of air openings 16a. The thermostat 22 may include a plurality of control buttons for selectively operating the heating process or the cooling process. The control buttons may be color coordinated to correspond to a heating process or a cooling process. So, for example, a blue button may correspond to cooling and a red button may correspond to heating. In essence, a user would actuate (e.g., depress) the blue button to initiate a cooling operation and the user would actuate the red button to initiate a heating operation.

Moreover, the control buttons may allow a user to choose a high or low heating or cooling setting. The heating process is regulated to operate at an acceptable standard temperature for a high setting and an acceptable standard temperature for a low setting. The cooling process is also regulated to operate at an acceptable standard temperature for a high setting and an acceptable standard temperature for a low setting. The control buttons may include a control button for manually turning off the selected cooling or heating process.

The device 10 may include a temperature sensor (i.e., safety sensor) for sensing the temperature of the air blown out of the vent assembly and for sensing the temperature of the seat cushion and the back rest. If the sensed temperature is outside of an acceptable temperature range for either the heating or cooling, the thermostat 22 turns off the heating or cooling process. Essentially, the thermostat would shut off power to the coil assembly once the temperature hit a certain mark to prevent overheating of the device or overcooling of the device. The thermostat may resume power to the coil assembly once the temperature subsides. gets too low, the relay will switch back on and the power from the battery will begin to reheat the seats.

In another exemplary embodiment, the thermostat 22 may include a display for displaying the sensed temperature.

The housing member 12 has a fan motor 18 and a cooler/compressor 20 integrated therein. The fan motor 18 includes fan blades which are turned to produce air to blow across the coil assembly. Any suitable fan motor may be used in the device. The cooler/compressor 20 is used to produce cooling and cool air. The cooler/compressor 20 compresses the liquid (e.g., refrigerant) in the coil assembly to get it to the right pressure and temperature before it passes through the condenser coil. Any suitable cooler/compressor may be used in the device 10.

The device 10 may be battery powered and operated. The device 10 includes a battery compartment 24 for storage of the battery. The battery may include rechargeable batteries. Any suitable rechargeable batteries may be used.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A temperature controlled child seat device comprising:
a housing member including a seat cushion and a back rest;
a coil assembly embedded in the housing member for selectively producing heat and cooling in the seat cushion and back rest;
a vent assembly integrated in the housing member, the vent member including a plurality of air openings and a vent line; and
a temperature control member for initiating a two-stage heating or cooling operation in correspondence with a user selection of heating or cooling, wherein the two-stage heating or cooling operation provides direct heating or cooling of the seat cushion and the back rest and provides heated or cooled air blown out of the vent assembly.

2. The device of claim 1, wherein the housing member is configured as a car seat.

3. The device of claim 1, wherein the housing member is configured as a stroller.

4. The device of claim 1, wherein the housing member includes a safety sensor for preventing the device from overheating.

5. The device of claim 1, wherein the coil assembly includes separate heating elements and cooling elements.

6. The device of claim 1, wherein the coil assembly includes a set of coils that may selectively operate as heating elements or cooling elements.

7. The device of claim 1, wherein the temperature control member includes control buttons for selecting a heating or cooling operation.

8. The device of claim 1, wherein a user can select a high or low setting for the heating or cooling operation.

9. The device of claim 1, wherein the temperature control member is a thermostat.
